(19) United States
(12) Patent Application Publication
(10) Pub. No.: US 2009/0058997 A1
(43) Pub. Date: Mar. 5, 2009

(54) ENDOSCOPE SYSTEM AND SIGNAL TRANSMITTING METHOD

(75) Inventor: Shuichi KATO, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/203,305

(22) Filed: Sep. 3, 2008

(30) Foreign Application Priority Data
Sep. 5, 2007 (JP) 2007-230362

(51) Int. Cl. H04N 7/18; H04B 1/02

(52) U.S. Cl. 348/65; 455/91; 348/E07.085

(57) ABSTRACT

An endoscope system comprises: an endoscope comprising an image pickup portion which performs image pickup; a signal processing apparatus which performs signal processing for an output signal from the image pickup portion; a signal transmitting portion which sends a video signal based on the output signal from the image pickup portion, by radio waves from the endoscope to the signal processing apparatus; and a transmission state detecting portion which detects a transmission state of the video signal in the signal transmitting portion. The signal transmitting portion includes: a signal sending portion and sends the video signal; and a signal receiving portion and receives the video signal sent by radio waves from the signal sending portion. The transmission state detecting portion detects the transmission state of the video signal by changing an output level of the signal sending portion or a receiving sensitivity level of the signal receiving portion.

### CROSS REFERENCE TO RELATED APPLICATION

This application claims benefit of Japanese Application No. 2007-230362 filed on Sep. 5, 2007, the contents of which are incorporated by this reference.

### BACKGROUND OF THE INVENTION

1. Field of the Invention

The present invention relates to an endoscope system and a signal transmitting method, which transmit a video signal of an endoscope by radio waves.

2. Description of the Related Art

In recent years, endoscopes have been widely used in various fields. The endoscopes require immersion disinfection/sterilization treatment with a disinfecting/sterilizing solution from the viewpoint of hygiene control. Therefore, each electric component must be protected from the disinfecting/sterilizing solution by waterproofing during the treatment such as sterilization.

Recently, another endoscope, called an electronic endoscope, has also been prevalent, which incorporates an image pickup portion or image pickup means. Alternatively, a TV camera-equipped endoscope has been sometimes used, which is an endoscope (more specifically, an optical endoscope) equipped with a television camera (TV camera) as an image pickup portion.

In the endoscope equipped with an image pickup portion, a video signal or an image signal based on an image pickup signal of an image picked up by the image pickup portion is transmitted to a video processor as a signal processing apparatus which performs signal processing in which the signal is converted to a standard video signal for display on a monitor. Then, an endoscopic image to be observed by an operator is displayed on a monitor screen to which the standard video signal is inputted.

Thus, the video signal by the image pickup portion in the endoscope must be transmitted to the video processor. In this context, when the endoscope is connected to the video processor through a wired signal line, an electrical contact portion of the endoscope with the video processor is exposed to the disinfecting solution or the like during the treatment. Thus, such an endoscope requires higher cost due to waterproofing of the electrical contact portion.

Therefore, the sterilization treatment or the like has previously been performed by covering the electrical contact portion with a waterproof membrane. Even if the electrical contact portion can be waterproofed, the electrical contact portion corrodes due to oxidation. Therefore, it is difficult to increase the longevity thereof.

Thus, signal transmission with the electrical contact portion hermetic is achieved by unwiring a portion of the signal line between the image pickup portion in the endoscope and the video processor. As a result, the endoscope is protected from the treatment such as sterilization without using a waterproof membrane. Some endoscopes based on such a system have been proposed.

For example, Japanese Patent Application Laid-Open Publication No. 2001-251611 as a first prior art discloses an approach which involves completely separating an endoscope from a video processor by transmitting a signal by radio waves via an antenna provided therein.

Alternatively, Japanese Patent Application Laid-Open Publication No. 10-155740 as a second prior art uses an approach which involves keeping only an electrical contact portion in isolation at close range and transmitting a signal by radio waves. This document discloses an optical transmission system using light as a communication medium.

Alternatively, Japanese Patent Application Laid-Open Publication No. 2007-97767 as a third prior art discloses transmission through an electrostatic coupling system, wherein electrostatic coupling is caused in short-distance space between surfaces of electrode pads facing each other. In general, signal transmission by radio waves is more susceptible to an external environment than wired signal transmission.

### SUMMARY OF THE INVENTION

An endoscope system of the present invention comprises:

an endoscope comprising an image pickup portion which performs image pickup;

a signal processing apparatus which performs signal processing for an output signal from the image pickup portion;

a signal transmitting portion which sends a video signal based on the output signal from the image pickup portion, by radio waves from the endoscope to the signal processing apparatus; and

a transmission state detecting portion which detects a transmission state of the video signal in the signal transmitting portion, wherein

the signal transmitting portion includes: a signal sending portion which is provided on the endoscope side and sends the video signal by radio waves; and a signal receiving portion which is provided on the signal processing apparatus side and receives the video signal sent by radio waves from the signal sending portion, and wherein

the transmission state detecting portion detects the transmission state of the video signal by changing an output level of the signal sending portion or a receiving sensitivity level of the signal receiving portion.

A signal transmitting method according to the present invention which sends a video signal based on image pickup by an image pickup portion, by radio waves from a signal sending portion provided in an endoscope to a signal receiving portion in a signal processing apparatus, comprises:

a first step of repetitively sending, as the video signal, test data from the signal transmitting portion by increasing or decreasing an output level of the test data by a predetermined amount on a one-frame/field basis from a first output level to a second output level;

a second step of receiving the test data by the signal receiving portion; and

a third step of detecting, as a transmission level, an output level corresponding to a boundary between an output level that generates an error rate less than a predetermined value and an output level that generates an error equal to or more than the predetermined value with respect to the error rate of the test data received in the second step.

### BRIEF DESCRIPTION OF THE DRAWINGS

FIG. 1 is a schematic configuration diagram of an electronic endoscope system of a first embodiment of the present invention;

FIG. 2 is a block diagram showing schematic configuration of a portion involved in a signal transmission system in the electronic endoscope system of the first embodiment;

FIG. 3 is a flow chart showing operation contents of signal transmission in the electronic endoscope system of the first embodiment;

FIG. 4 is a diagram showing a signal transmission example in the first embodiment, wherein test data is transmitted on the basis of one frame data of a video signal;

FIG. 5 is a schematic configuration diagram of an electronic endoscope system of a second embodiment of the present invention;

FIG. 6 is a block diagram showing schematic configuration of a portion involved in a signal transmission system in the electronic endoscope system of the second embodiment; and

FIG. 7 is a flow chart showing operation contents of signal transmission in the electronic endoscope system of the second embodiment.

### DETAILED DESCRIPTION OF THE PREFERRED EMBODIMENTS

Next, embodiments of the present invention will be described with reference to the drawings.

### First Embodiment

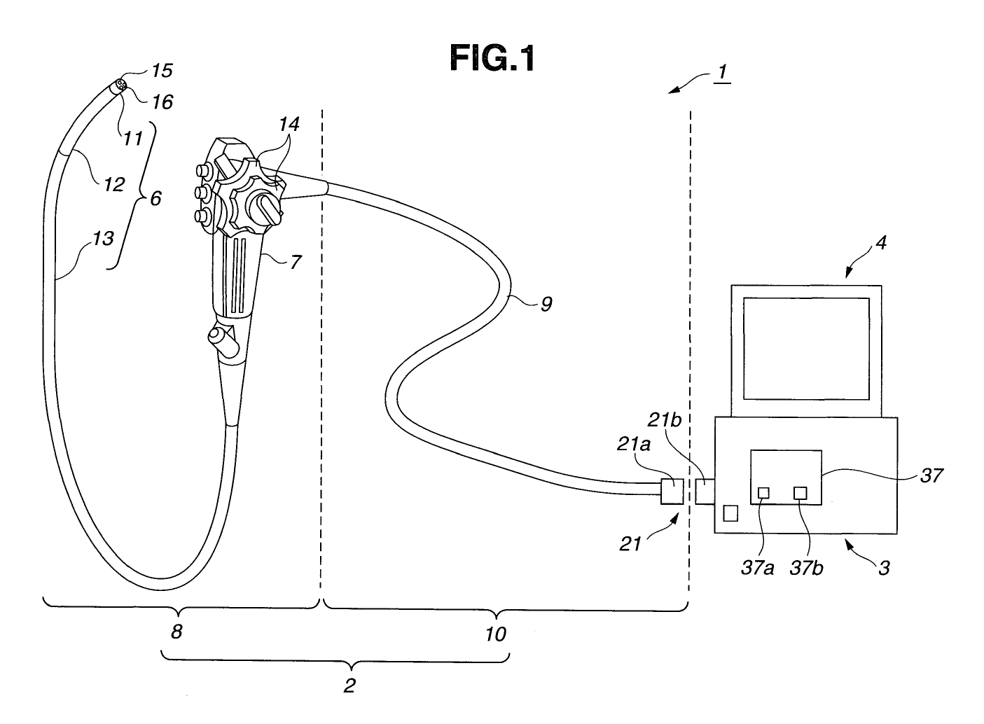

A first embodiment of the present invention will be described. FIG. 1 shows schematic configuration of an electronic endoscope system 1 according to the first embodiment of the present invention.

The electronic endoscope system 1 has: an electronic endoscope 2 which is inserted into a human body and used in endoscopy; a video processor 3 as a signal processing apparatus which performs signal processing for an image signal by an image pickup portion incorporated in the electronic endoscope 2; and a monitor 4 which displays an endoscopic image corresponding to a video signal outputted from the video processor 3.

The electronic endoscope 2 is equipped with: an electronic endoscope portion 8 having an elongated insertion portion 6 which is inserted into a human body and an operation portion 7 provided at a proximal end of the insertion portion 6; and a connecting cord portion 10 having a universal cord 9 extended from the operation portion 7.

The insertion portion 6 has: a distal end portion 11 provided at a distal end of the insertion portion 6; a freely bendable bending portion 12 provided at a rear end of the distal end portion 11; and a long flexible portion 13 extended from a rear end of the bending portion 12 to a front end of the operation portion 7.

The operation portion 7 is provided with a bending knob 14 which performs bending operation of the bending portion 12. An operator as a user who uses the electronic endoscope 2 grasps the operation portion 7 and can bend the bending portion 12 by operating the bending knob 14.

The distal end portion 11 is provided with an illumination window 15 and an observation window 16. For example, LED (not shown) which emits illumination light is attached to the illumination window 15. When the insertion portion 6 is inserted into a human body, a site to be observed in the human body can be illuminated with illumination light emitted from the illumination window 15.

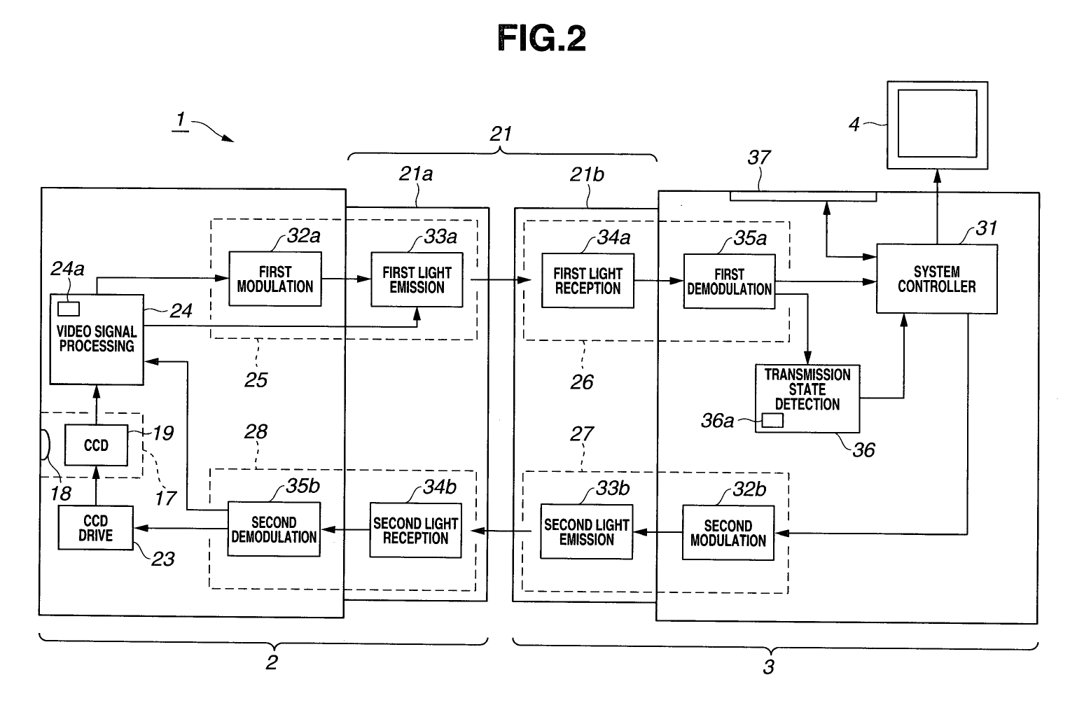

An objective lens 18 configuring an image pickup portion 17, as shown in FIG. 2, is attached to the observation window 16. The objective lens 18 forms an optical image of the site to be observed illuminated with illumination light, on, for example, CCD 19 as an image pickup device placed at the image-forming location.

As shown in FIG. 1, an end portion of the universal cord 9 extended from the operation portion 7 is provided with a connector for radio transmission (hereinafter, simply abbreviated to radio connector) 21a. The radio connector 21 a can be removably connected to a radio connector receiver 21b provided on case surface of the video processor 3.

The radio connector 21a and the radio connector receiver 21b, as described later with reference to FIG. 2, form a radio connector portion 21 (as signal transmitting means) which transmits a signal by radio waves without using electrical contact.

The video processor 3 generates a clock signal serving as a basic clock for driving the CCD 19 of the image pickup portion 17 incorporated in the electronic endoscope 2, while the video processor 3 receives, via the radio connector portion 21, a video signal (more specifically, a modulated video signal) sent by radio waves from the electronic endoscope 2 side.

The video processor 3 then demodulates the received video signal and further performs signal processing in which a standard video signal is generated. Then, the signal is outputted to the monitor 4. An image picked up by the image pickup portion 17 is displayed as an endoscopic image on a screen of the monitor 4.

Next, configuration of a signal processing system according to the present embodiment will be described with reference to FIG. 2. FIG. 2 shows configuration of the signal processing system including signal transmitting means according to the present embodiment.

As shown in FIG. 2, the electronic endoscope 2 according to the present embodiment has in addition to the image pickup portion 17: a CCD drive circuit 23 which drives the CCD 19 configuring the image pickup portion 17; and a video signal processing circuit 24 which performs signal processing for an image signal as a CCD output signal outputted from the CCD 19, to generate a video signal.

The video signal processing circuit 24 converts an analog baseband video signal generated by CDS processing for the CCD output signal, to a binarized digital video signal through A/D conversion, and further generates a serial digital video signal generated by a parallel-serial conversion circuit.

The electronic endoscope 2 is also equipped with a first signal sending portion 25 which configures the signal transmitting means which sends, by radio waves, a video signal outputted from the video signal processing circuit 24. The video signal is received by a first signal receiving portion 26 on the video processor 3 side.

The electronic endoscope 2 also has a second signal receiving portion 28 which receives a clock signal sent from a second signal sending portion 27 in the video processor 3, by radio waves via the radio connector portion 21.

The CCD drive circuit 23 generates a CCD driving signal using a clock signal generated by the second signal receiving portion 28, and drives the CCD 19.

In this context, the video processor 3 is provided with a system controller 31 which outputs a clock signal to the second signal sending portion 27 and outputs, to the monitor 4, a video signal demodulated by the first signal receiving portion 26.

The first signal sending portion 25 has: a first modulation circuit 32a; and a first light emitting portion 33a which transmits, through an optical transmission system, a video signal modulated by the first modulation circuit 32a. In this context, the first light emitting portion 33a is provided within the radio connector 21a.

The second signal sending portion 27 provided within the video processor 3 has: a second modulation circuit 32b which modulates a clock signal generated by, for example, a clock signal generation circuit within the system controller 31; and a second light emitting portion 33b which sends, through an optical transmission system, the clock signal modulated by the second modulation circuit 32b.

In this context, the second light emitting portion 33b is provided within the radio connector receiver 21b. The system controller 31 controls the whole electronic endoscope system 1.

The second signal receiving portion 28 provided within the electronic endoscope 2 has: a second light receiving portion 34b provided within the radio connector 21a; and a second demodulation circuit 35b which demodulates a light signal received by the second light receiving portion 34b. The second demodulation circuit 35b outputs the demodulated clock signal to the CCD drive circuit 23.

The first signal receiving portion 26 has: a first light receiving portion 34a provided within the radio connector receiver 21b; and a first demodulation circuit 35a which demodulates a video signal received through optical coupling by the first light receiving portion 34a. The first demodulation circuit 35a outputs the demodulated video signal to the system controller 31.

The video processor 3 is also provided with a transmission state detecting portion 36 (as means for detecting a transmission state of a video signal) to which a video signal outputted from the first demodulation circuit 35a is inputted.

The transmission state detecting portion 36 detects a transmission state of a video signal sent by radio waves through optical coupling from the first signal sending portion 25 to the first signal receiving portion 26, and outputs information on the detection results to the system controller 31.

In this context, in a state where the radio connector 21a and the radio connector receiver 21b are attached to each other, the first light emitting portion 33a and the first light receiving portion 34a face each other, while the second light emitting portion 33b and the second light receiving portion 34b face each other, for example, as shown in FIG. 2.

Light (signal) emitted from the first light emitting portion 33a is received by the first light receiving portion 34a, while light (signal) emitted from the second light emitting portion 33b is received by the second light receiving portion 34b.

The system controller 31 controls the detection operation of the transmission state by the transmission state detecting portion 36. In usual (default) setting, the transmission state detecting portion 36 performs the detection operation of the transmission state immediately after turning-on of power to the electronic endoscope system 1.

In this setting, endoscopy is started after turning-on of power. Therefore, the transmission state is detected immediately before the start of endoscopy. Thus, the endoscopy is easily performed in an appropriate setting state corresponding to the transmission state.

The system controller 31 cautions or notifies a user such as an operator, by a beeper or the like, that the detection results of the transmission state are in an unsuitable state for transmission. The user easily takes an appropriate response with reference to the detection results such as caution, for example, to continue endoscopy or set the radio connector portion 21 to a more clean state.

The detection operation of the transmission state is also performed in the middle of actual sending of a video signal. Objective information (specifically, a transmission level) corresponding to the transmission state at the point in time is displayed on the monitor 4 or the like. The operator can confirm the transmission state of the video signal even in the middle of endoscopy with reference to the information.

As described later, the transmission level in this case is determined by changing an output level of test data sent for detecting an error rate, and transmitting the test data. Then, an output level that produces detection results in which an error rate detected by measurement in the transmission is changed to equal to or more than a predetermined value is detected (calculated) as the transmission level.

Therefore, from a state of an output level of a video signal in actual video signal transmission, whether or not the transmission state of the video signal is good can be objectively confirmed by confirming the transmission level.

For a supplementary explanation, if a transmission state at a certain point in time is detected or judged to be less than a predetermined value serving as a threshold between good and poor transmission states, it can be judged that the transmission state at the point in time is good. However, objective information such as a margin to an unsuitable state for transmission cannot be obtained only from the judgment results. Therefore, it is difficult to judge whether or not good transmission is stably performed.

By contrast, if information is obtained as to a boundary between a good transmission state that produces a small error rate and a transmission state unsuitable for transmission that produces an error rate equal to or more than a predetermined value, nearly objective information on the transmission state is obtained.

For example, when an output level serving as a boundary on which an error rate becomes unsuitable for transmission is defined as a transmission level, signal transmission is performed by setting an output level with a sufficient margin for the output level (unsuitable for transmission). As a result, it can be objectively judged that the signal transmission can be stably performed in a good transmission state.

In this context, the detection operation of the transmission state can be performed besides on turning-on of power by user's operation from, for example, a transmission state detection starting switch 37a (see FIG. 1) in an operation panel 37 provided in the video processor 3, or a keyboard (not shown). As a result, the system controller 31 can control start of the detection operation of the transmission state at the operation timing.

In this case, the system controller 31 superimposes an instruction signal for starting the detection operation of the transmission state, onto a clock signal, and outputs the signal to the second signal sending portion 27.

The instruction signal is then sent from the second signal sending portion 27 to the second signal receiving portion 28 and demodulated by the second demodulation circuit 35b. The demodulated instruction signal is outputted to the video signal processing circuit 24.

The video signal processing circuit 24 has, for example, a test data generation circuit 24a which generates test data prepared in advance therewithin. Usually, the detection operation of the transmission state is started, when the power is turned on. Furthermore, the same operation is also started, when the instruction signal is inputted. At the start of the detection operation of the transmission state, the video signal processing circuit 24 does not output a video signal based on an output signal from the CCD 19 but outputs test data generated in the test data generation circuit 24a to the first signal sending portion 25.

In this case, the video signal processing circuit 24 controls the first light emitting portion 33a configuring the first signal sending portion 25, to emit light at, for example, predetermined emission intensity or emission output (hereinafter, indicated by an output level; specifically, the predetermined emission output corresponds to output level 3) which is considered as a standard. At the predetermined output level 3, a transmission error rate (bit error rate, hereinafter, abbreviated to an error rate) is then calculated by the transmission state detecting portion 36.

The video signal processing circuit 24 transmits test data at the predetermined output level 3 and then starts sending operation of a video signal, while the video signal processing circuit 24 further controls transmission by changing an output level N (N=1 to 9) of test data with a predetermined period such that the output level is sequentially decreased from a nearly biggest output level (specifically, output level 9).

In a state where the output level N is periodically changed, the transmission state detecting portion 36 then detects a transmission error rate by measurement. From changes in error rate attributed to the changes in the output level N, the transmission state (more specifically, a transmission level serving as a boundary between good and poor error rates) is detected. A bit pattern of the test data is known for the transmission state detecting portion 36. The transmission state detecting portion 36 has, therewithin, a storing portion 36a which stores information on the same bit pattern as that of the transmitted test data.

The transmission state detecting portion 36 calculates (detects), by measurement, a transmission error rate by comparing the demodulated test data outputted from the first demodulation circuit 35a, that is, the transmitted test data, with information read from the storing portion 36a, and outputs the calculation results to the system controller 31.

The system controller 31 performs control according to the results of the transmission error rate provided by the transmission state detecting portion 36.

For example, when transmission at the predetermined output level 3 is judged as failed transmission due to an error rate equal to or more than a threshold, the system controller 31 cautions a user by, for example, LED or the beeper 37b (see FIG. 1) in the operation panel 37 and notifies the user of the failed transmission.

When transmission at periodically changed output level N is judged as failed transmission with an error rate equal to or more than the predetermined value (threshold) changed from an error rate smaller than the threshold, the output level N serving as a boundary on which the change occurs is displayed as a transmission level as information on the detection of the signal transmission state.

Thus, the system controller 31 performs control involved in the operation of the transmission state using test data. In the present embodiment, the signal transmitting means by radio waves is based on the optical transmission system. Therefore, a video signal is sent at an output level that gives largest light emission (specifically, output level 10) in the first light emitting portion 33a.

Operation in which an image picked up by the CCD 19 is displayed as an endoscopic image on the monitor 4 will be described below.

A clock signal generated by the system controller 31 is modulated in the second signal sending portion 27 that functions as clock signal sending means, and then converted to a light signal for sending. The light signal is received by the second signal receiving portion 28 that functions as clock signal receiving means. After photoelectric conversion, the signal is demodulated by the second demodulation circuit 35b and transmitted to the CCD drive circuit 23.

The CCD drive circuit 23 generates a horizontal transfer pulse, a reset pulse, a vertical transfer pulse, and the like, as a driving signal for driving the CCD 19, based on the clock signal, and drives the CCD 19. After image pickup by the CCD 19 and photoelectric conversion, an image pickup signal outputted therefrom is CDS-processed by the video signal processing circuit 24 and further converted to a video signal converted to serial data, after A/D conversion.

The video signal is transmitted by radio waves from the first signal sending portion 25 configuring the video signal transmitting means in the electronic endoscope 2 via the radio connector portion 21 to the first signal receiving portion 26 in the video processor 3, and further transmitted to the system controller 31. The system controller 31 performs signal processing for the transmitted video signal and converts the signal to a standard video signal, which is in turn outputted to the monitor 4. An endoscopic image is displayed on a screen of the monitor 4.

Operation in which the transmission state is detected using the transmission state detecting portion 36 will be schematically described below.

At the start of the detection operation of the transmission state, the video signal processing circuit 24 outputs not a video signal from the CCD 19 but test data prepared in advance. An output signal of the test data arrives at the transmission state detecting portion 36 via the first signal sending portion 25 and the first signal receiving portion 26.

In this context, the transmission state detecting portion 36 measures a transmission error rate by comparing the test data transmitted via the radio connector portion 21, with the original test data, and transmits the results to the system controller 31.

The system controller 31 performs caution or the like according to the detected transmission error rate.

Following the detection operation of the transmission state using test data, an output level of the test data is changed, as described below, even in the middle of transmission of a video signal. When an error rate is changed by the changes in output level, detection is performed to obtain information on the signal transmission state from the output level.

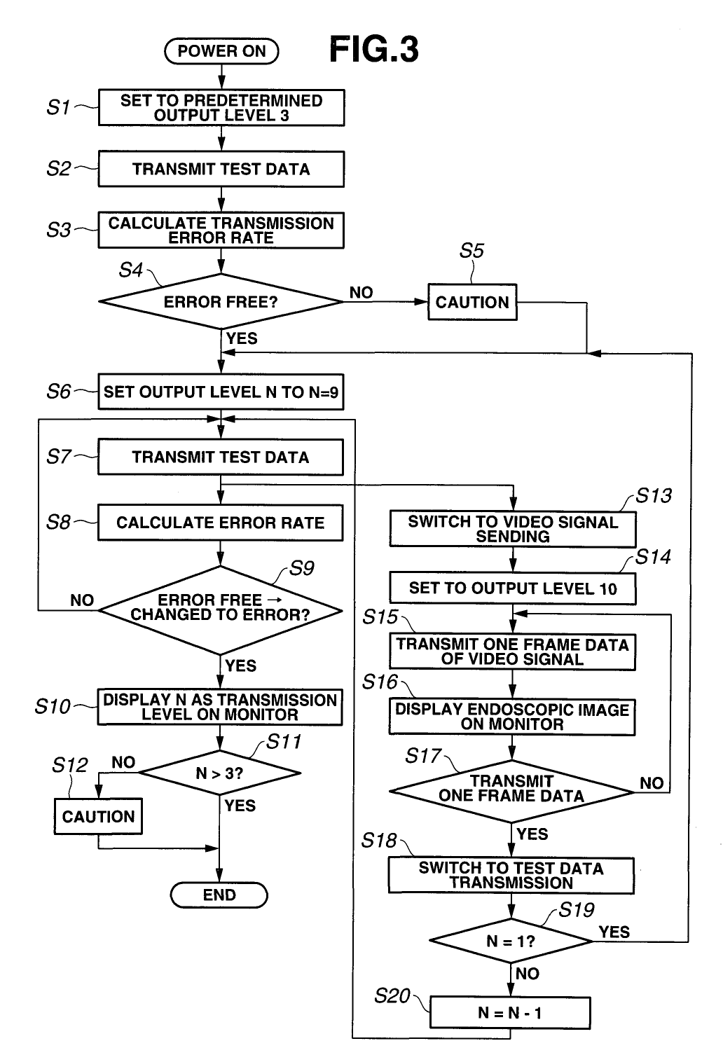

Next, operation of the electronic endoscope system 1 of the present embodiment will be described with reference to FIG. 3. FIG. 3 shows a flow chart of operation contents in the electronic endoscope system 1 shown in FIGS. 1 and 2. In the electronic endoscope system 1 described with reference to FIG. 3, an output level serving as emission intensity of the first light emitting portion 33a can be set on a scale of 1 to 10.

When the power of the electronic endoscope system 1 is turned on in a state where the radio connector 21a in the electronic endoscope 2 is attached to the radio connector receiver 21b in the video processor 3, the electronic endoscope 2 and the video processor 3 go into an operation state.

In this context, the electronic endoscope 2 incorporates a battery (not shown) as a power source. In another configuration, instead of the battery, an AC power supplied from the video processor 3 side via, for example, an electromagnetic coupling coil to the radio connector portion 21 may be rectified to generate a DC power.

Illumination is performed with LED (not shown) as illuminating means. The illuminating means is not limited to the LED. In one configuration, a light guide may be inserted into the electronic endoscope 2, and illumination light supplied from the video processor 3 side may be transmitted through the light guide and emitted, for illumination, from surface of the distal end.

When the electronic endoscope 2 and the video processor 3 go into an operation state, the video signal processing circuit 24 sets, in a first step S1, output level 3 that provides emission intensity of the first light emitting portion 33a at a standard level. In a next step S2, the video signal processing circuit 24 outputs test data to the first signal sending portion 25. The test data is transmitted from the first signal sending portion 25 to the first signal receiving portion 26.

The test data demodulated by the first signal receiving portion 26 is inputted to the transmission state detecting portion 36. As shown in a step S3, the transmission state detecting portion 36 calculates (measures) a transmission error rate and transmits the results to the system controller 31.

In a step S4, the system controller 31 judges whether or not a transmission state is good with a transmission error rate less than the threshold (abbreviated to error free) at the predetermined output level 3. When the transmission state is judged as error free, the process goes to a step S6. When the transmission state is judged as failed transmission with an error rate equal to or more than the threshold, caution is performed by the beeper 37b or the like, as shown in a step S5, and the process then goes to the step S6.

In the step S6, the video signal processing circuit 24 sets output level N to (nearly largest output level) 9 for test data transmission. In a next step S7, the test data is transmitted.

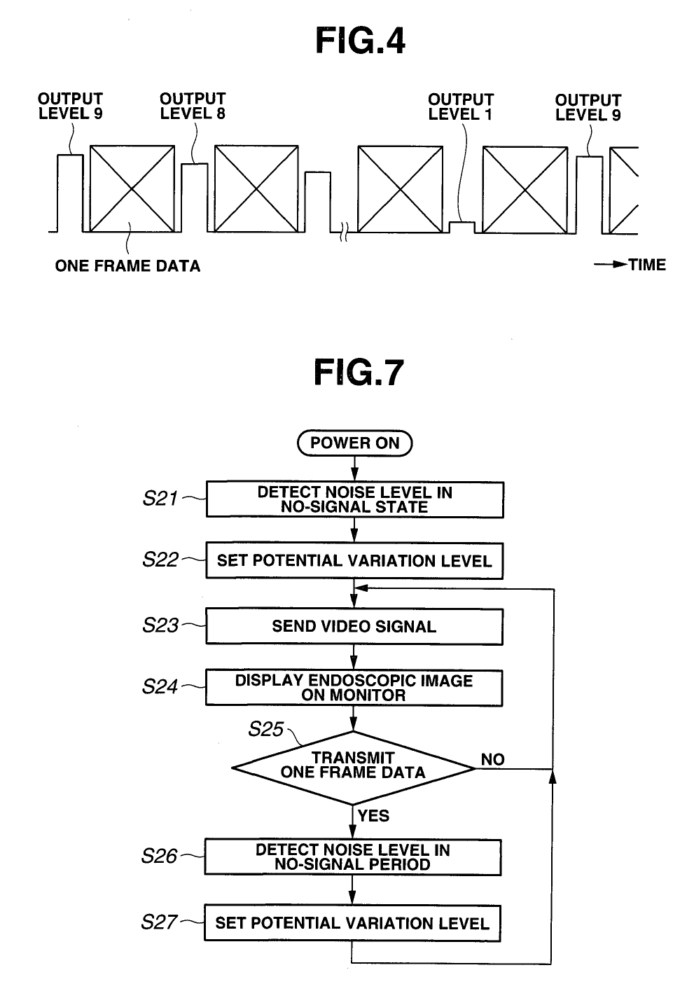

In the step S6 and subsequent steps, one frame data of a video signal fixed to, for example, the largest output level and test data at gradually changed output level N are alternately outputted, as shown in FIG. 4, with a predetermined period from the video signal processing circuit 24 to the first signal sending portion 25.

The periodically (on a regular basis) sent test data is inputted to the transmission state detecting portion 36. As shown in a step S8, the transmission state detecting portion 36 calculates a transmission error rate and transmits the results to the system controller 31. In a step S9, the system controller 31 judges whether error free is changed to a state with an error.

After the test data transmission in the step S7, the video signal processing circuit 24 also performs sending operation of a video signal, as shown in steps S13 to S16 described later. Specifically, the processes in the step S6 and subsequent steps detect the transmission state using the test data on a regular basis in the middle of transmission of a video signal (i.e., also image display based on the video signal).

The output level N of the test data is decreased from the output level 9 by one, as described above. When the output level reaches 1, the process returns to the step S6.

Therefore, the output level for transmitting test data is set to the output level 9 in the step S6, but changes so as to be decreased by the routines of steps S13 to S20.

In the step S9, when error free is not changed to a state with an error, the process returns to the step S7. On the contrary, when error free is changed to a state with an error, the system controller 31 displays, in a next step S10, the output level N or a transmission level corresponding to N, for example, on the monitor 4. The processes shown in FIG. 3 are finished, or the process returns to the step S6.

In a step S11 subsequent to the step S10, the system controller 31 judges whether or not the output level N satisfies N>3. When the output level N satisfies the condition N>3, the processes shown in FIG. 3 are finished, or the process returns to the step S6.

On the other hand, when the output level N is equal to or smaller than 3, the system controller 31 performs caution by the beeper 37b or the like, as shown in a step S12. The processes shown in FIG. 3 are finished, or the process returns to the step S6.

As described above, the video signal processing circuit 24 sets, in the step S7, the output level for test data to 9 and, after sending, is switched to a state where a video signal is sent (outputted), as shown in a step S13.

Then, the video signal processing circuit 24 sets, in a step S14, the output level to the largest output level 10. In a step S15, the video signal processing circuit 24 outputs one frame data of a video signal to the first signal sending portion 25. The video signal is sent from the first signal sending portion 25.

The sent video signal is received by the first signal receiving portion 26 and demodulated. The demodulated signal is then subjected to further signal processing by the system controller 31 and converted to a standard video signal. A corresponding endoscopic image is displayed on the monitor 4 (step S16).

As shown in a next step S17, the video signal processing circuit 24 monitors whether or not one frame data of a video signal is transmitted. When one frame data is not transmitted, the process returns to the step S15 to continue video signal sending.

On the other hand, the video signal processing circuit 24 is switched to test data output (transmission) at the time when the transmission of one frame data is finished (step S18). In a next step S19, whether or not the level N is 1 is judged. When the output level falls at N=1, the process returns to the step S6. The output level N is set again to the output level 9, and the same operation is repeated.

When the output level is judged as being not N=1, the output level N is set to N=N−1, as shown in a step S20, and the process returns to the step S7.

In the period when test data is transmitted on a regular basis during video signal transmission, the transmission state detecting portion 36 detects the transmission state, as shown in the steps S7 to S12. In this case, when an error rate is calculated (step S8) and switched from error free to a state with an error, the value N of the output level N in the test data transmission is displayed as a latest (at the point in time) signal transmission level on the monitor 4 (step S10).

The output level N at which the switching occurs can be judged as a boundary level between an error and error free and can be defined as a transmission level. When the transmission level N is equal to or smaller than 3, the system controller 31 judges the transmission as a failed transmission state and performs caution (step S12), for example, by sounding the beeper 37b.

Thus, according to the first embodiment described above, the transmission state is detected immediately after turning-on of power to the electronic endoscope system 1 and during operation of the electronic endoscope system 1. A user is notified of reduction in transmission state by the beeper 37b or the like. Thus, the user easily performs corresponding treatment in endoscopy, and ease of operation is improved.

Specifically, in the reduction in transmission state, the user can easily appropriately perform radio transmission through the optical transmission system, for example, by wiping end surface of the radio connector portion 21, and performs the procedures in a short time.

According to the first embodiment, a state of a transmission level serving as a boundary on which an error rate is changed can be confirmed on the monitor 4 during operation of the electronic endoscope system 1. Therefore, the user grasps transition in the transmission state and easily operates corresponding procedures from information on the transmission state.

For example, when procedures such as endoscopy which is difficult to suspend or treatment under endoscopy are performed, a transmission level is confirmed before start of the procedures. For example, at a marginal transmission level (determined from e.g., a value of a difference between an output level used in video signal transmission and the transmission level), the transmission state is improved, and the procedures are then started. Thus, a response is easily taken according to the situation, and ease of operation can be improved.

In the description above, a case in which an output level of a video signal is fixed to the largest level is described. However, the output level may be changed according to detection results of a transmission level. For example, at a low transmission level, the output level may be made lower than the largest level to reduce power consumption.

In the description above, when the transmission state is detected, an error rate is measured by changing an output level for transmitting test data, and a signal transmission state (transmission level) is detected from the measurement results.

By contrast, an error rate may be measured by changing a receiving sensitivity level on the signal receiving side, specifically, in the first signal receiving portion 26, and a signal transmission state (transmission level) may be detected from the measurement results. This approach also produces the same effects.

In the description above, a case in which an output level of test data is decreased by a predetermined amount on a one-frame basis is described. However, the output level may be decreased on a field basis instead of the frame basis. Alternatively, the output level may be increased instead of being decreased.

### Second Embodiment

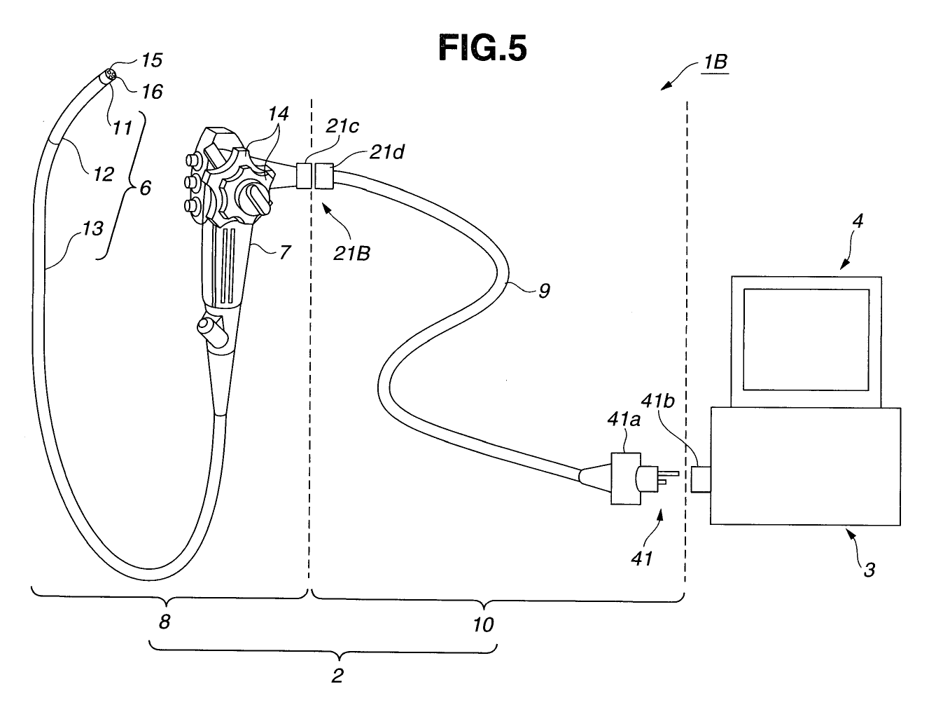

Next, a second embodiment of the present invention will be described with reference to FIG. 5. FIG. 5 shows schematic configuration of an electronic endoscope system 1B of the second embodiment of the present invention. In FIG. 5, the same reference numerals as those in FIG. 1 will be used to designate the same configuration members as those in FIG. 1, so that the description will be omitted.

In the electronic endoscope system 1B shown in FIG. 5, the operation portion 7 in the electronic endoscope 2 and the proximal end of the universal cord 9 are removably provided with a radio connector 21c and a radio connector receiver 21d, respectively. Thus, video signal transmission is performed without electrical contact by a radio connector portion 21B having the radio connector 21c and the radio connector receiver 21d.

The other end of the universal cord 9 is provided with, for example, a connector 41a having electrical contact. The connector 41a is removably connected to a connector receiver 41b provided in the video processor 3.

The connector 41a and the connector receiver 41b configure a connector portion 41 which connects the electronic endoscope 2 and the video processor 3. In this context, the connector 41a shown in FIG. 5 is also equipped with, for example, a light guide connector which performs illumination light transmission. The connector having electrical contact is not limited to the shape shown in FIG. 5.

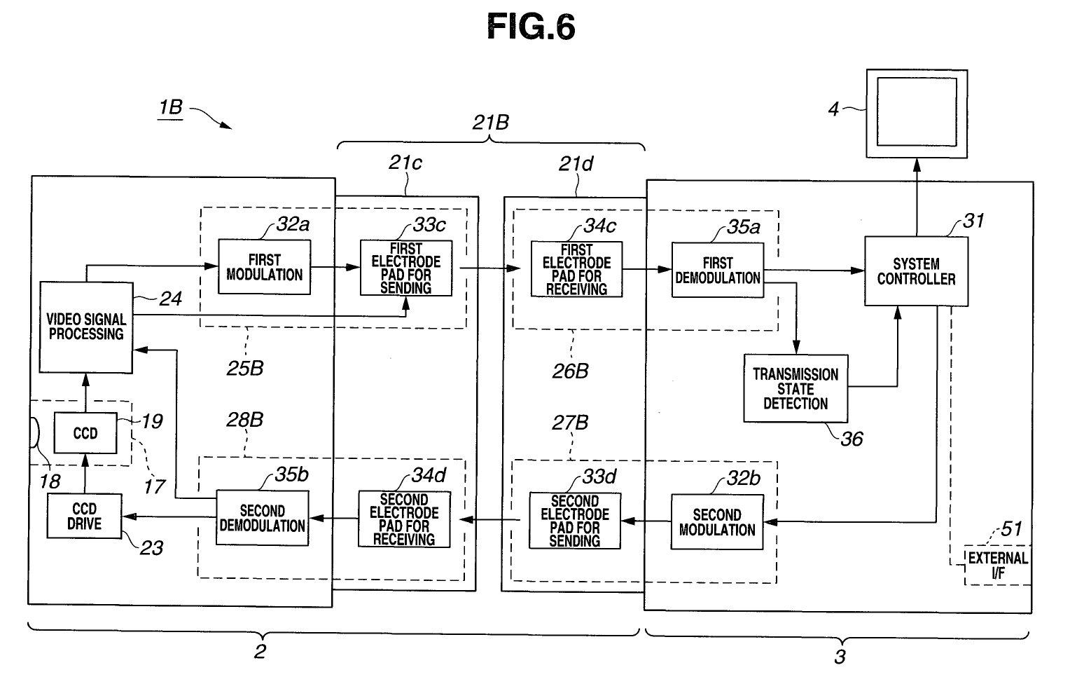

FIG. 6 shows a functional block of a signal processing system of the electronic endoscope system 1B. The electronic endoscope system 1B is functionally similar to the electronic endoscope system 1 of FIG. 2. In the electronic endoscope system 1 of FIG. 2, signal transmission by the radio connector portion 21 is performed through optical coupling. By contrast, in the radio connector portion 21B in the electronic endoscope system 1B of the present embodiment, signal transmission is performed through electrostatic coupling.

Specifically, a first electrode pad 33c for sending and a first electrode pad 34c for receiving, as shown in FIG. 6, are used instead of the first light emitting portion 33a and the first light receiving portion 34a in the first signal sending portion 25 and the first signal receiving portion 26 of FIG. 2 to form a first signal sending portion 25B and a first signal receiving portion 26B, respectively.

Moreover, a second electrode pad 33d for sending and a second electrode pad 34d for receiving, as shown in FIG. 6, are used instead of the second light emitting portion 33b and the second light receiving portion 34c in the second signal sending portion 27 and the second signal receiving portion 28 of FIG. 2 to form a second signal sending portion 27B and a second signal receiving portion 28B, respectively.

The first electrode pad 33c for sending and the first electrode pad 34c for receiving are placed to face each other at short range and thereby form electrostatic coupling. As a result, a signal (potential variation) of the first electrode pad 33c for sending is transmitted by radio waves via electrostatic coupling to the first electrode pad 34c for receiving. Likewise, a signal of the second electrode pad 33d for sending is transmitted by radio waves via electrostatic coupling to the second electrode pad 34d for receiving.

In the present embodiment, detection operation of a transmission state, as described later, is performed in a no-signal state where a video signal is not sent from the first signal sending portion 25B.

In a usage state (of endoscopy) where a video signal is sent, the detection operation of the transmission state is performed in a no-signal state in a predetermined period that serves as a breakpoint of the video signal and is free from the video signal (no-signal period). In the present embodiment, the video signal processing circuit 24 adjusts an output level of a video signal outputted from the video signal processing circuit 24. As a result, a potential variation level (sending level) of the first electrode pad 33c for sending can be changed.

Alternatively, signal detection sensitivity (gain) of the first signal receiving portion 26B is enhanced. As a result, a potential variation level (receiving level) can be changed by the first electrode pad 34c for receiving under the control of the system controller 31.

In addition, for example, a changeable distance between the first electrode pad 33c for sending and the first electrode pad 34c for receiving, that is, a changeable electrostatic coupling amount, may be achieved by applying, for example, an electrical signal of a piezoelectric element to the electrode pad 33c or 34c. Furthermore, the electrostatic coupling amount may be adjusted, for example, under the control of the system controller 31.

In this case, a noise level is detected in a period when a video signal is stopped (referred to as a no-signal period) and a potential variation level that gives an electrostatic coupling amount can be set, in which the noise level is small. Configuration of the other electrical system in FIG. 6 is similar to that shown in FIG. 2.

Next, a flow for displaying a video signal by the CCD 19 as an endoscopic image on the monitor 4 will be described. A clock signal as a basic clock generated by the system controller 31 is transmitted by radio waves to the CCD drive circuit 23 via the second signal sending portion 27B and the second signal receiving portion 28B.

The CCD drive circuit 23 generates a drive pulse for driving the CCD 19, based on the clock signal, and drives the CCD 19. The output signal from the CCD 19 is then A/D-converted in the video signal processing circuit 24 and then converted to serial data.

The video signal is transmitted to the system controller 31 via the first signal sending portion 25B and the first signal receiving portion 26B. The system controller 31 performs signal processing for the video signal and generates a standard video signal, which is in turn outputted to the monitor 4. An endoscopic image is displayed on a screen of the monitor 4. Next, a flow for detecting a transmission state by the transmission state detecting portion 36 will be described. When the transmission state is detected, operation of the first signal sending portion 25B is stopped. The first signal receiving portion 26B directly detects an exogenous noise as a noise level via the first electrode pad 34c for receiving. The detected noise level is then sampled by the transmission state detecting portion 36 and transmitted to the system controller 31.

In the transmission system through electrostatic coupling, the biggest obstacle to signal transmission is an exogenous noise. Therefore, the system controller 31 (or the transmission state detecting portion 36) calculates the transmission state at the noise level attributed to the exogenous noise in a no-signal state.

Next, operation of the electronic endoscope system 1B of the present embodiment will be described. FIG. 7 is a flow chart showing operation of the electronic endoscope system 1B shown in FIGS. 5 and 6.

In the electronic endoscope system 1B according to the flow chart of FIG. 7, a potential variation level (sending level) can be changed between the first electrode pad 33c for sending and the second electrode pad 33d for sending.

Hereinafter, operation of the electronic endoscope system 1B will be described with reference to the flow chart of FIG. 7. Immediately after turning-on of power to the electronic endoscope system 1B, the transmission state detecting portion 36, as shown in a step S21, detects a noise level and transmits the results to the system controller 31.

In this case, operation of the first signal sending portion 25B is stopped, as described above. The detection of the noise level is performed in a no-signal state where a video signal is not transmitted.

In a next step S22, the system controller 31 changes potential variation levels of the first electrode pad 33c for sending and the second electrode pad 33d for sending and thereby sets the potential variation levels of the first electrode pad 33c for sending and the second electrode pad 33d for sending such that a ratio of a noise level to a signal level (S/N ratio) is made larger.

When the detected transmission level is reduced in the setting of potential variation levels, the transmission state can be improved by increasing an output level in signal sending or changing a receiving sensitivity level in signal receiving. Alternatively, when the detected transmission state is excessively good, power consumption can be reduced by decreasing an output level in signal sending or a receiving sensitivity level in signal receiving.

In this context, the system controller 31 may display the detected noise level on the monitor 4 or the like and may notify a user of information thereon.

In a next step S23, the video signal processing circuit 24 starts operation in which the video signal is sent by one frame data.

As shown in a step S24, the sent video signal is then received by the first signal receiving portion 26B and converted through the system controller 31 to a standard video signal, which is in turn outputted to the monitor 4. An endoscopic image is displayed on the monitor 4.

As shown in a step S25, the video signal processing circuit 24 judges whether one frame data of a video signal is transmitted. When the transmission of one frame data is not finished, the process returns to the step S23 to continue the sending operation of one frame data.

On the other hand, when one frame data of a video signal is transmitted, a no-signal period when a video signal is not sent is started, as shown in a step S26. In the no-signal period, the transmission state detecting portion 36 detects a noise level and transmits the results to the system controller 31.

As shown in a step S27, the system controller 31 sets potential variation levels according to the detected noise level.

In this case, to circumvent influence of the detected noise level, potential variation levels of the first electrode pad 33c for sending and the second electrode pad 33d for sending are set to levels at which an exogenous noise does not influence signal transmission.

In the step S27, for example, the transmission state can be improved or an appropriate transmission state is set, or power consumption can be reduced, as in the step S22.

In the step S27, the detected noise level may be displayed on the monitor 4 or the like.

After the processes in the step S27, the process returns to the step S23, and the same operation is repeated. According to the present embodiment, a sending level can be changed (to a level unsusceptible to an exogenous noise) at real time according to a level of the exogenous noise. Thus, the transmission state can be favorably maintained, even when an environment in which the electronic endoscope system 1B is used is changed.

In the process operation shown by the flow chart of FIG. 7, the setting of potential variation levels (S21 and S22) is always performed at the start of use of the electronic endoscope system 1B. However, the setting of potential variation levels may be performed in synchronization with, for example, operation of an endoscope peripheral device or an electric knife device as an endoscope-related device, and may be performed only in combined use of the electric knife device therewith.

In another configuration, turning-on/off of power to the electric knife device or a signal of its operation mode may be transmitted to the system controller 31 of FIG. 6. For example, as shown by the dotted line in FIG. 6, the electric knife device is connected to the system controller 31 via an external I/F device 51. In this configuration, turning-on/off of power to the electric knife device or a signal of its operation mode is transmitted to the system controller 31.

In further configuration, the system controller 31 may perform setting such that, for example, the potential variation levels can be automatically switched in response to start of operation of the electric knife device or its operation mode. Alternatively, the detection of the transmission state may be performed at a timing synchronized with start of operation of the electric knife device or its operation mode.

In the second embodiment, an error rate may be measured, as in the first embodiment, by transmitting test data and changing an output level of the test data or changing a signal receiving sensitivity level on the receiving side, and a transmission state (transmission level) may be detected from the measurement results.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. An endoscope system comprising:
an endoscope comprising an image pickup portion which performs image pickup;
a signal processing apparatus which performs signal processing for an output signal from the image pickup portion;
a signal transmitting portion which sends a video signal based on the output signal from the image pickup portion, by radio waves from the endoscope to the signal processing apparatus; and
a transmission state detecting portion which detects a transmission state of the video signal in the signal transmitting portion, wherein
the signal transmitting portion includes: a signal sending portion which is provided on the endoscope side and sends the video signal by radio waves; and a signal receiving portion which is provided on the signal processing apparatus side and receives the video signal sent by radio waves from the signal sending portion, and wherein
the transmission state detecting portion detects the transmission state of the video signal by changing an output level of the signal sending portion or a receiving sensitivity level of the signal receiving portion.

2. The endoscope system according to claim 1, wherein
the transmission state detecting portion measures an error rate by changing the output level of the signal sending portion or the receiving sensitivity level of the signal receiving portion from a first level to a second level different from the first level, and detects, as information on the transmission state of the video signal, a level serving as a boundary on which an error rate less than a predetermined value becomes equal to or more than the predetermined value.

3. The endoscope system according to claim 1, wherein
the signal transmitting portion transmits the video signal by use of electrostatic coupling, and wherein
the transmission state detecting portion measures a level of an exogenous noise detected in the signal receiving portion in a state where sending operation by the signal sending portion is stopped, and detects the transmission state of the video signal from the measurement results.

4. The endoscope system according to claim 1, wherein
the transmission state detecting portion performs the detection of the transmission state of the video signal immediately after turning-on of power to the endoscope system.

5. The endoscope system according to claim 1, wherein
the transmission state detecting portion performs the detection of the transmission state of the video signal on a regular basis during operation of the endoscope system.

6. The endoscope system according to claim 1, wherein
the transmission state detecting portion performs the detection of the transmission state of the video signal at a timing instructed by a user.

7. The endoscope system according to claim 1, wherein
the transmission state detecting portion performs the detection of the transmission state of the video signal at a timing synchronized with operation of an endoscope peripheral device other than the endoscope.

8. The endoscope system according to claim 1, further comprising
a displaying portion which displays information corresponding to the transmission state detected by the transmission state detecting portion.

9. The endoscope system according to claim 1, further comprising
a notifying portion which notifies a user of information associated with the transmission state, based on the transmission state detected by the transmission state detecting portion.

10. The endoscope system according to claim 1, wherein
the output level of the signal sending portion or the receiving sensitivity level of the signal receiving portion is switched based on the transmission state detected by the transmission state detecting portion.

11. The endoscope system according to claim 1, wherein
the endoscope sends, as the video signal, an image pickup signal of an image picked up by the image pickup portion and a test signal having a predetermined bit pattern, by radio waves from the signal sending portion.

12. The endoscope system according to claim 1, wherein
the signal transmitting portion transmits the video signal by use of optical coupling.

13. The endoscope system according to claim 11, wherein
the transmission state detecting portion has a storing portion which stores information on the same bit pattern as that of the test signal sent from the signal sending portion.

14. The endoscope system according to claim 13, wherein
the transmission state detecting portion detects an error rate using information from the storing portion, when receiving a sent test signal.

15. The endoscope system according to claim 11, wherein
the signal sending portion periodically sends the test signal by sequentially increasing or decreasing an output level of the test signal by a predetermined amount.

16. The endoscope system according to claim 1, wherein
the signal transmitting portion further comprises a clock transmitting portion which transmits a clock signal by radio waves from the signal processing apparatus side to the image pickup portion on the endoscope side.

17. A signal transmitting method which sends a video signal based on image pickup by an image pickup portion, by radio waves from a signal sending portion provided in an endoscope to a signal receiving portion in a signal processing apparatus, the method comprising:
a first step of repetitively sending, as the video signal, test data from the signal transmitting portion by increasing or decreasing an output level of the test data by a predetermined amount on a one-frame/field basis from a first output level to a second output level;
a second step of receiving the test data by the signal receiving portion; and
a third step of detecting, as a transmission level, an output level corresponding to a boundary between an output level that generates an error rate less than a predetermined value and an output level that generates an error equal to or more than the predetermined value with respect to the error rate of the test data received in the second step.

18. The signal transmitting method according to claim 17, wherein
the signal sending portion superimposes, for sending, the test data onto a video signal generated based on image pickup by the image pickup portion.

19. The signal transmitting method according to claim 17, further comprising
cautioning that the output level detected as the transmission level is unsuitable for transmission, when the output level is equal to or more than the predetermined level.

20. The signal transmitting method according to claim 18, wherein
the signal transmitting portion makes, for sending, an output level of the video signal larger than the transmission level.
